(19) United States
(12) Patent Application Publication
(10) Pub. No.: US 2025/0242365 A1
(43) Pub. Date: Jul. 31, 2025

(54) HANDHELD AIRLESS SPRAYER

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 18/986,073

(22) Filed: Dec. 18, 2024

(30) Foreign Application Priority Data
Dec. 19, 2023 (CN) 2023234659365
Feb. 28, 2024 (CN) 2024203738435

(51) Int. Cl. B05B 9/04; F16K 17/04

(52) U.S. Cl. CPC B05B 9/0403; F16K 17/0473

(57) ABSTRACT

A handheld airless sprayer prevents a spray effect affected by piston movement frequency. The handheld airless sprayer includes a casing, liquid cup, nozzle, pump body, actuation mechanism, and liquid outlet valve, the nozzle located at the casing front end, the pump body including a pump chamber, a pump chamber liquid inlet end connects to the liquid cup, a pump chamber liquid outlet end connects to the liquid outlet valve, which includes a valve body with buffer chamber, and valve seat, valve head, and spring in the valve body; a liquid outlet hole communicates with the valve seat nozzle; the valve body spring closes the liquid outlet hole; the pump body draws liquid from the liquid cup into the buffer chamber; and the valve head opens when buffer chamber liquid pressure exceeds a preset pressure, whereby the buffer chamber liquid flows through the liquid outlet hole to spray from the nozzle.

### FIELD

The subject matter described herein relates to a sprayer, and more particularly relates to a handheld airless sprayer.

### BACKGROUND

A handheld airless sprayer, also called a handheld high-pressure airless paint sprayer, is a spray gun powered by a battery pack to spray a paint or coating pressurized by a high-pressure piston pump body.

For existing handheld airless sprayers, their spray effect is usually affected by piston movement frequency of their piston pump body, i.e., the higher the piston movement frequency is, the more uniformly the liquid is sprayed out of a nozzle, the more consistently the paint is sprayed, and the better the spray effect is, while the lower the piston movement frequency is, the more inconsistently the paint is sprayed, and the more unsatisfactory the spray effect is.

### SUMMARY

A technical problem to be solved by the disclosure is mitigating the impact of piston movement frequency on spray effect, so as to prevent spray inconsistency in a case of low-frequency piston movement, thereby improving spray quality.

A handheld airless sprayer is described, comprising: a casing, a liquid cup, a nozzle, a pump body, an actuation mechanism, and a liquid outlet valve, the nozzle being disposed at a front end of the casing, the pump body being provided with a pump chamber, a liquid inlet end of the pump chamber being connected to the liquid cup via a first check valve, a liquid outlet end of the pump chamber being connected to the liquid outlet valve via a second check valve, characterized in that the liquid outlet valve comprises a valve body, a valve seat, a valve head, and a spring, the valve body being provided with a buffer chamber, the valve seat, the valve head, and the spring being arranged in the valve body; a liquid outlet hole communicating with the nozzle is provided on the valve seat; the spring acts on the valve head to bias the valve head towards a direction of closing the liquid outlet hole; the actuation mechanism activates the pump body to draw liquid from the liquid cup into the buffer chamber; and the valve head is opened when a liquid pressure in the buffer chamber exceeds a preset liquid outlet pressure, whereby the liquid in the buffer chamber flows through the liquid outlet hole and is sprayed out of the nozzle.

In some implementations, the valve seat comprises a valve seat body and a poppet, the poppet being fixedly connected to the valve seat body in a detachable manner, the poppet being mounted at one end of the valve seat body distal from the nozzle, a limiting cavity configured to limit the valve head and the spring being formed between the poppet and the valve seat body, the valve head being movable in the limiting cavity.

In some implementations, the poppet is hollow inside and provided with a liquid inlet hole communicating with the liquid outlet hole, the valve head being operable to open and close the liquid inlet hole leading to opening and closing of the liquid outlet hole.

In some implementations, the liquid outlet valve further comprises a valve stem, the valve stem being slidably arranged in the valve seat body, the valve stem and the valve seat body being peripherally sealed so that a sealing cavity is formed between the valve stem and the poppet, the spring being disposed in the sealing cavity, one end of the spring abutting against the poppet, an opposite end of the spring abutting against the valve stem, the valve head being disposed on the valve stem; and the valve head comprises a conical tip, the conical tip being partially inserted in the liquid outlet hole to close the liquid outlet hole.

In some implementations, a fixed holder is arranged in one end of the valve body proximal to the pump body; the valve body further comprises a valve stem, the valve head being fixed on the valve stem; a blind hole is provided on the fixed holder, one end of the valve stem being movably inserted in the blind hole, one end of the spring abutting against the fixed holder, an opposite end of the spring abutting against the valve stem; and the valve head comprises a conical tip, the conical tip being partially inserted in the liquid outlet hole to close the liquid outlet hole.

In some implementations, the actuation mechanism acts on the pump body to induce volume change of the pump chamber, a ratio of maximum volume of the pump chamber to a liquid accommodable volume of the buffer chamber ranging from 1:1 to 1:50.

In some implementations, the pump body is further provided with a pressure relief passage, the pressure relief passage comprising a first passage section communicating with the pump chamber and a second passage section communicating with the liquid cup; and a pressure relief valve is arranged between the first passage section and the second passage section, a prese relief pressure of the pressure relief valve being greater than the preset liquid outlet pressure of the liquid outlet valve.

In some implementations, the pressure relief valve comprises a pressure relief valve body, a pressure relief poppet, a pressure relief valve stem, a pressure relief valve head, and a pressure relief spring; a first pressure relief hole and a second pressure relief hole that communicate with each other are provided on the pressure relief valve body, the first pressure relief hole communicating with the first passage section, the second pressure relief hole communicating with the second passage section; the pressure relief valve stem is movably mounted on the pressure relief poppet; one end of the pressure relief spring abuts against the pressure relief poppet, and an opposite end thereof abuts against the pressure relief valve stem; the pressure relief valve head is fixed on the pressure relief valve stem; a conical surface is formed on the pressure relief valve head; and the pressure relief spring acts on the pressure relief valve stem to bias the conical surface in a direction towards the first pressure relief hole, the first pressure relief hole being closed by the pressure relief valve head when liquid pressure in the buffer chamber is lower than the preset relief pressure.

In some implementations, the pressure relief valve further comprises a pressure relief bonnet, the pressure relief valve stem extending in a direction opposite the first passage section to project out of the pressure relief bonnet; and a manipulator is mounted at a tail end of the pressure relief valve stem, the manipulator being operable such that the pressure relief valve head opens the first pressure relief hole, leading to active pressure relief of the pressure relief valve.

In some implementations, the manipulator comprises a rotary knob, the rotary knob being cover-fitted on the pressure relief bonnet and rotatable relative to the pressure relief bonnet, a support portion being arranged on one of the pressure relief bonnet and the rotary knob, an abutting portion being arranged on the other one of the pressure relief bonnet and the rotary knob, the pressure relief spring acting on the rotary knob so that the abutting portion abuts against the support portion; and the support portion comprises a first support section and a second support section, wherein when the abutting portion abuts against the first support section, the pressure relief valve releases pressure actively, and when the abutting portion abuts against the second support section, the pressure relief valve suspends active pressure relief.

In some implementations, the support portion further comprises a partition section arranged between the first support section and the second support section, a surface of the partition section changing gradually in a direction from the first support section towards the second support section.

In some implementations, the abutting portion is formed of a convex arc shape, and the second support section is formed of a concave arc shape adapted to the abutting portion.

In some implementations, the first support section is at least partially formed of a concave arc shape adapted to the abutting portion.

With the technical solutions noted supra, the disclosure offers the following benefits:
1. The handheld airless sprayer described herein enables pre-pressurization of a to-be-sprayed liquid in the buffer chamber formed in the valve body of the liquid outlet valve; since much to-be-sprayed liquid is stored in the buffer chamber with a uniform liquid pressure, the pressure of the sprayed liquid can be still maintained at a liquid drawing interval of the pump body, thereby preventing inconsistent spray and enhancing spray effect of the sprayer.

2. By disposing the poppet at one end of the valve seat distal from the nozzle and limiting the valve head and the spring between the valve seat body and the poppet, the size of the valve seat may be reduced, which increases the available volume of the buffer chamber, reduces the size of the liquid outlet valve while satisfying spray requirements, and reduces material overhead of the liquid outlet valve. Meanwhile, the detachable fixed connection between the poppet and the valve seat body facilitates dismantling and internal cleaning of the valve seat. Furthermore, by forming the limiting cavity between the poppet and the valve seat body, where the valve head is limitedly movable in the limiting cavity, the valve seat, the valve head, and the spring form a detachable modular structure, so that the valve head and the spring are well kept upon dismantling the valve seat, which facilitates the user to assemble the valve seat and the valve body.

3. By providing the liquid inlet hole on the poppet, the liquid pressure in the buffer chamber may directly act on the valve head, which facilitates opening of the valve head and improves spray sensitivity of the sprayer.

4. The valve stem is disposed in the valve body, the valve stem and the valve seat body are peripherally sealed to form a sealing cavity between the valve stem and the poppet, and the spring is disposed in the sealing cavity; as such, the spring is isolated from the liquid without being rusted by the liquid.

5. One end of the valve stem is movably attached to the fixed holder, and the opposite end thereof is secured to the valve head; since the valve head is provided with a conical tip to open and close the liquid outlet hole, the structure is simple and reliable.

6. By reasonably setting the volume ratio between the pump chamber and the buffer chamber, the buffer chamber may achieve good liquid storage effect and buffer effect, thereby improving spray quality of the sprayer.

7. By providing a pressure relief passage in the pump body, the liquid directly flows from the pressure relief passage back into the liquid cup when the pressure in the buffer chamber or the pump chamber is excessively large, thereby preventing the actuation mechanism from being heated due to an overly high working resistance.

8. The pressure relief valve further comprises a pressure relief bonnet, the pressure relief valve stem passing through the pressure relief bonnet and being mounted with a manipulator; the manipulator is operable such that the pressure relief valve head opens the first pressure relief hole, whereby the pressure relief valve performs active pressure relief. In this way, the user may release pressure actively via the pressure relief valve, preventing the buffer chamber from still maintaining a high-pressure state after the handheld airless sprayer is deactivated.

9. The manipulator comprises a rotary knob, the rotary knob being cover-fitted on the pressure relief bonnet and rotatable relative to the pressure relief bonnet. When the abutting portion abuts against the first support section, the pressure relief valve releases pressure actively. When the abutting portion abuts against the second support section, the pressure relief valve suspends active pressure relief. In this way, by rotating the rotary knob so that the abutting portion abuts against different positions on the support portion, the pressure relief valve may perform pressure relief actively or suspends the active pressure relief, which facilitates manipulation of the manipulator.

10. The surface of the partition section changes gradually in the direction from the first support section towards the second support section; as such, the rotary knob may be fitted with the partition section so that the rotary knob is rotated to shift between the first support section and the second support section. The abutting portion may shift its position on the support portion during rotation of the rotary knob without a need for the user to lift the rotary knob, which facilitates manipulation of the manipulator in active pressure relief.

11. Since the abutting portion has a convex arc shape and the second support section has a concave arc shape adapted to the abutting portion, the abutting portion slides more smoothly between the first support section and the second support section. Meanwhile, since the second support section has a shape adapted to the abutting portion, the abutting portion and the second support section may hold their positions better when the pressure relief valve suspends active pressure relief, thereby reducing or avoiding their relative displacement.

12. The first support section at least partially has a concave arc shape adapted to the abutting portion; as such, the abutting portion may hold its position when abutting against the first support section, which reduces or prevents the abutting portion from slipping off the first support section upon active pressure relief.

### BRIEF DESCRIPTION OF THE DRAWINGS

FIG. 1 is a structural diagram of a sprayer;

FIG. 2 is a structural diagram of a pump body and a valve body in the sprayer;

FIG. 3 is a partial sectional structural view of the sprayer in a front-rear direction when a liquid outlet valve adopts a first alternative solution;

FIG. 4 is a partial structural view of FIG. 3;

FIG. 5 is a partial structural view when a valve head is spherical;

FIG. 6 is a partial sectional structural view of the sprayer in a front-rear direction when the liquid outlet valve adopts a second alternative solution;

FIG. 7 is a partial structural view of FIG. 6;

FIG. 8 is a partial sectional structural view of the sprayer in a front-rear direction when the liquid outlet valve adopts a third alternative solution;

FIG. 9 is a partial structural view of FIG. 8;

FIG. 10 is a partial sectional structural view of the sprayer in a direction perpendicular to the front-rear direction when a pressure relief valve adopts a first alternative solution;

FIG. 11 is a partial structural view of FIG. 10;

FIG. 12 is a partial sectional structural view of the sprayer in a direction perpendicular to the front-rear direction when the pressure relief valve adopts a second alternative solution;

FIG. 13 is a structural view of a pressure relief bonnet in FIG. 12;

FIG. 14 is a structural diagram of a rotary knob in FIG. 12.

In the drawings: 100—casing; 110—liquid cup; 120—nozzle; 130—actuation mechanism; 131—piston; 140—pump body; 141—pump chamber; 141a—liquid inlet end; 141b—liquid outlet end; 142—pressure relief valve mount portion;
200—liquid outlet valve; 201—first check valve; 210—valve body; 211—buffer chamber; 212—fixed holder; 2121—blind hole; 220—valve seat; 221—valve seat body; 222—poppet; 223—limiting cavity; 224—liquid outlet hole; 225—liquid inlet hole; 226—recessed groove; 227—liquid inlet flow passage; 228—sealing cavity; 230—valve head; 231—conical tip; 240—spring; 250—valve plate; 260—valve stem;
270—pressure relief passage; 271—first passage section; 272—second passage section; 280—pressure relief valve; 281—pressure relief valve housing; 2811—first pressure relief hole; 2812—second pressure relief hole; 282—pressure relief poppet; 283—pressure relief valve stem; 284—pressure relief valve head; 2841—conical surface; 285—pressure relief spring; 286—pressure relief bonnet; 290—manipulator; 291—rotary knob; 292—support portion; 2921—first support section; 2922—second support section; 2923—partition section; 293—abutting portion;
310—exhaust base; 311—exhaust hole; 320—exhaust plug

### DETAILED DESCRIPTION OF EMBODIMENTS

Hereinafter, the technical solutions of the disclosure will be explained and illustrated through implementations with reference to the accompanying drawings. However, the implementations described herein are only some implementations of the disclosure, not all of them. Other implementations obtained by those skilled in the art based on the examples in the implementations without exercise of inventive work all fall within the protection scope of the disclosure.

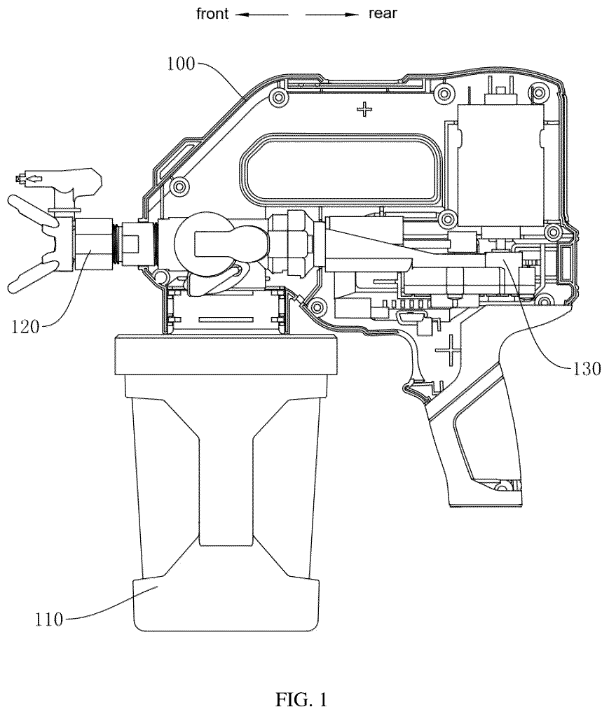

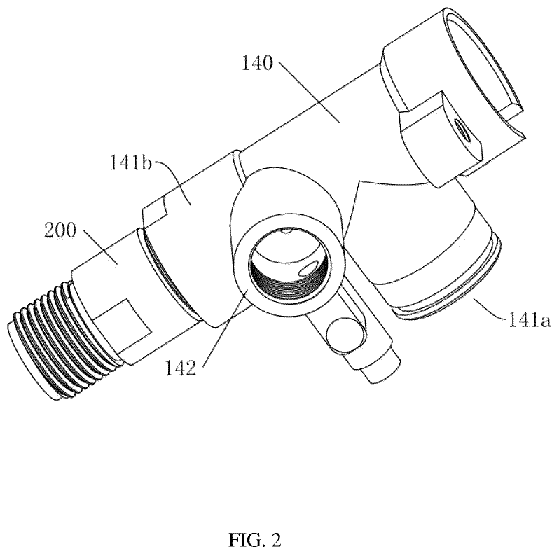

As illustrated in FIGS. 1 through 5, a handheld airless sprayer according to some implementations of the disclosure comprises: a casing 100, a liquid cup 110, a nozzle 120, a pump body 140, an actuation mechanism 130, and a liquid outlet valve 200, the nozzle 120 being disposed at a front end of the casing 100, the liquid cup 110 being configurable to store a to-be-sprayed liquid. The pump body 140 comprises a pump chamber 141, a liquid inlet end 141a of the pump chamber 141 being connected to the liquid cup 110 via a first check valve 210, a liquid outlet end 141b of the pump chamber 141 being connected to the liquid outlet valve 200 via a second check valve 202. The liquid outlet valve 200 comprises a valve body 210, a valve seat 220, a valve head 230, and a spring 240; the valve body 210 is provided with a buffer chamber 211; the valve seat 220, the valve head 230, and the spring 240 are provided in the valve body 210; a liquid outlet hole 224 communicating with the nozzle 120 is provided on the valve seat 220; the spring 240 acts on the valve head 230 to bias the valve head 230 in a direction of closing the liquid outlet hole 224. The actuation mechanism 130 activates the pump body 140 to draw liquid from the liquid cup 110 into the buffer chamber 211; the valve head 230 is opened when liquid pressure in the buffer chamber 211 exceeds a preset liquid outlet pressure, whereby the liquid in the buffer chamber 211 flows through the liquid outlet hole 224 and is sprayed out of the nozzle 120.

By forming the buffer chamber 211 in the valve body 210 of the liquid outlet valve 200, the liquid is pre-pressurized in the buffer chamber 211 before being sprayed out; since much liquid is stored in the buffer chamber 211 with a uniform liquid pressure, the pressure of sprayed liquid can be still maintained at a liquid drawing interval of the pump body 140, which prevents occurrence of discontinued spray and enhances spray effect of the sprayer.

The actuation mechanism 130 comprises a piston 131, the piston 131 moving back and forth in the pump body 140 to induce volume change of the pump chamber 141. When the piston 131 moves backwards, the volume of the pump chamber 141 increases, the first check valve 201 is opened, the liquid in the liquid cup 110 flows into the pump chamber 141, and the second check valve 202 limits the liquid in the liquid outlet valve 200 from flowing back into the pump chamber 141. When the piston 131 moves forwards, the volume of the pump chamber 141 decreases, the second check valve 202 is opened, the liquid in the pump chamber 141 is pumped into the liquid outlet valve 200, and the first check valve 201 limits the liquid in the pump chamber 141 from flowing back into the liquid cup 110. The actuation mechanism 130 and the pump body 140 form a positive displacement pump, which may adopt a conventional piston pump, a diaphragm pump, or a screw pump, etc.

In this implementation, a recessed groove 226 is arranged on an outer peripheral surface of the valve seat 220, a seal ring being provided at the recessed groove 226. The seal ring maintains peripheral sealing between the valve seat 220 and the valve body 210, preventing the liquid in the buffer chamber 211 from leaking outward via a gap between the valve seat 220 and the valve body 210.

To improve liquid storage effect and buffer effect of the buffer chamber 211, in this implementation, a ratio of maximum volume of the pump chamber 141 to an accommodable liquid volume of the buffer chamber 211 is set in a range from 1:1 to 1:50. If the buffer chamber 211 is set with an overly large volume, the residual liquid in the buffer chamber 211 cannot be discharged after the spray ends, easily causing waste. If the buffer chamber 211 is set with an overly small volume, the liquid storage effect and buffer effect of the buffer chamber 211 would be affected. By setting an appropriate volume ratio between the buffer chamber 211 and the pump chamber 141, the buffer chamber 211 may achieve desired liquid storage effect and buffer effect, thereby improving spray quality of the sprayer. In some implementations, the ratio of the maximum volume of the pump chamber 141 to the accommodable liquid volume of the buffer chamber 211 is set in a range from 1:10 to 1:40. Furthermore, the volume ratio is set in a range from 1:1 to 1:30. Yet furthermore, the volume ratio is set in a range from 1:1 to 1:20. As a feasible solution of this implementation, the volume ratio therebetween may be set to 1:5, 1:6, 1:7, 1:8, 1:9, or 1:10, etc.

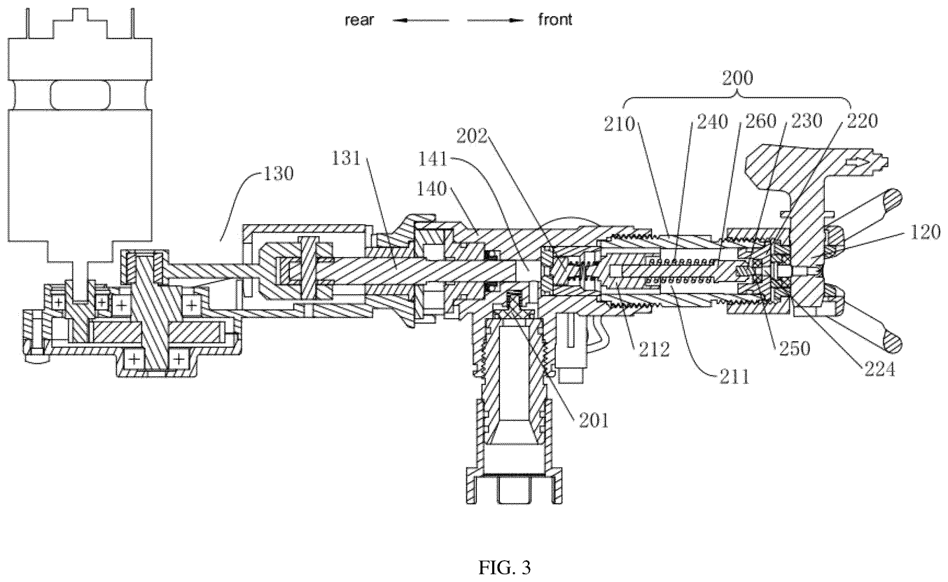

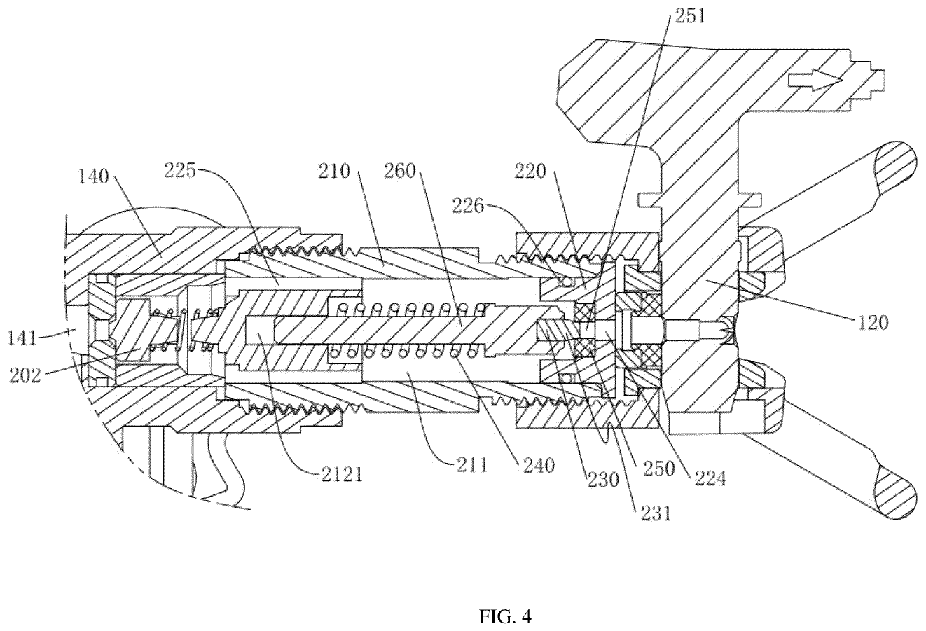

FIGS. 3 and 4 illustrate a first alternative solution of the liquid outlet valve 200 in this implementation, in which a fixed holder 212 is provided at one end of the valve body 210 proximal to the pump body 140, the fixed holder 212 being configured to support the second check valve 202, the fixed holder 212 being hollowed out to form at least one liquid inlet hole 225. The liquid outlet valve 200 further comprises a valve stem 260, a blind hole 2121 being provided at one end of the fixed holder 212 facing away from the second check valve 202, a rear end of the valve stem 260 being movably inserted in the blind hole 2121, the valve head 230 being fixed at a front end of the valve stem 260. A rear end of the spring 240 abuts against the fixed holder 212, and a front end thereof abuts against the valve stem 260, the spring 240 biasing the valve head 230 in a direction of closing the liquid outlet hole 224. The valve head 230 comprises a conical tip 231, and a valve plate 250 is provided at the liquid outlet hole 224, the valve plate 250 and the valve seat 220 being axially sealed; a through hole 251 communicating with the liquid outlet hole 224 is arranged on the valve plate 250, the conical tip 231 being partially inserted in the through hole 251 to close the liquid outlet hole 224, a remaining portion of the conical tip 231 being disposed in the buffer chamber 211.

The liquid pressure in the buffer chamber 211 is imposed peripherally on the valve head 230. The liquid pressure may be decomposed into forces in a direction opposite the liquid outlet hole 224 and forces in a direction towards a center of the valve head 230; the peripheral forces imposed towards the direction of the center of the valve head 230 counteract each other; after the forces opposite the liquid outlet hole 224 are superimposed to exceed the preset liquid outlet pressure, the liquid pushes the valve head 230 to move in the direction opposite the liquid outlet hole 224, forcing the valve head 230 to open the liquid outlet hole 224, whereby the liquid may enter the nozzle 120 from between the valve head 230 and the liquid outlet hole 224 and is sprayed out.

Since the fixed holder 212 is arranged at one end of the valve body 210 proximal to the pump body 140, the rear end of the valve stem 260 is movably attached to the fixed holder 212, the valve head 230 is fixed at the front end of the valve stem 260, and the valve head 230 adopts a conical tip 231 to enable closing and liquid discharging of the liquid outlet valve 200, a simplified and reliable structure is offered with a lower cost.

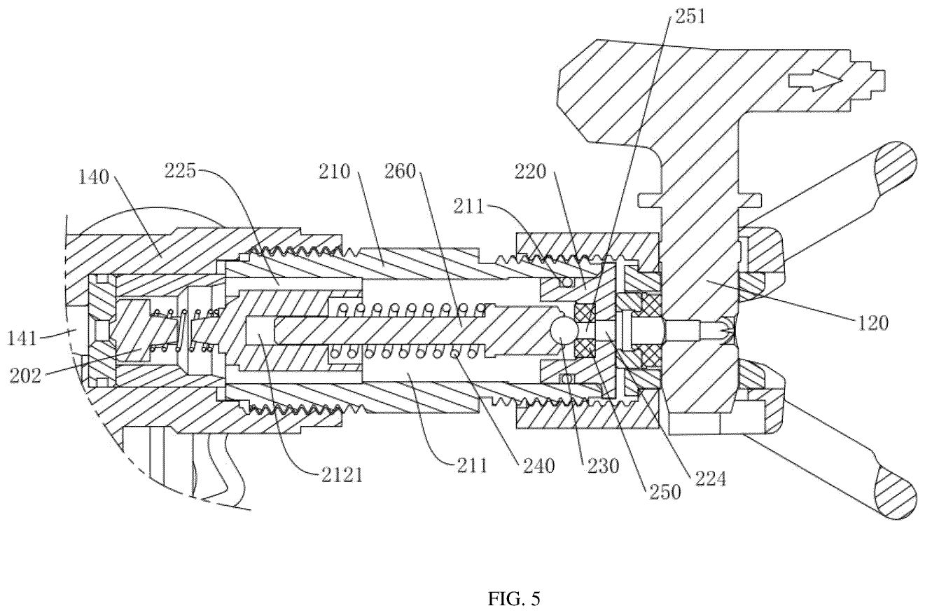

Referring to FIG. 5 based on the structure of the liquid outlet valve 200 illustrated in FIGS. 3 and 4, the valve head 230 may also be formed of a spherical shape.

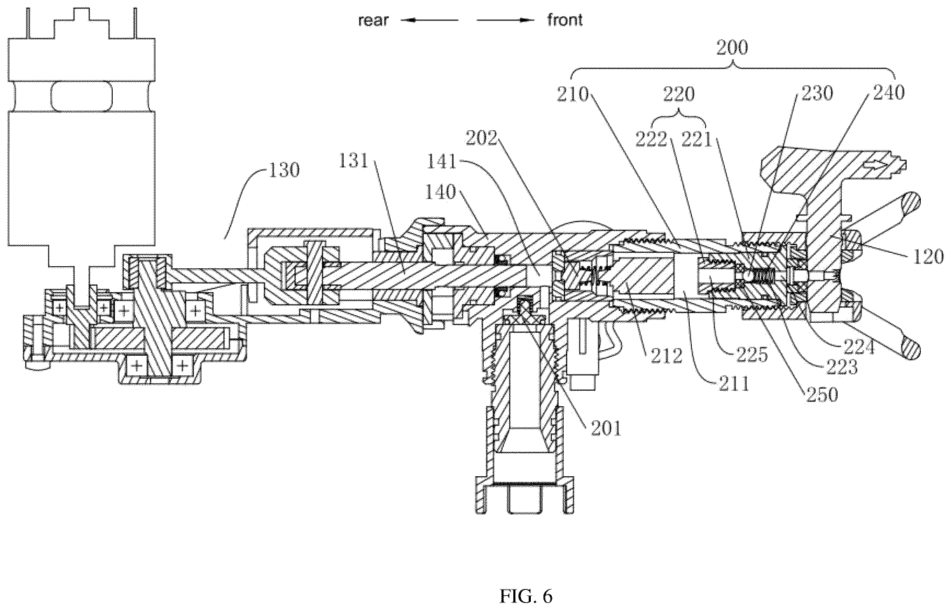

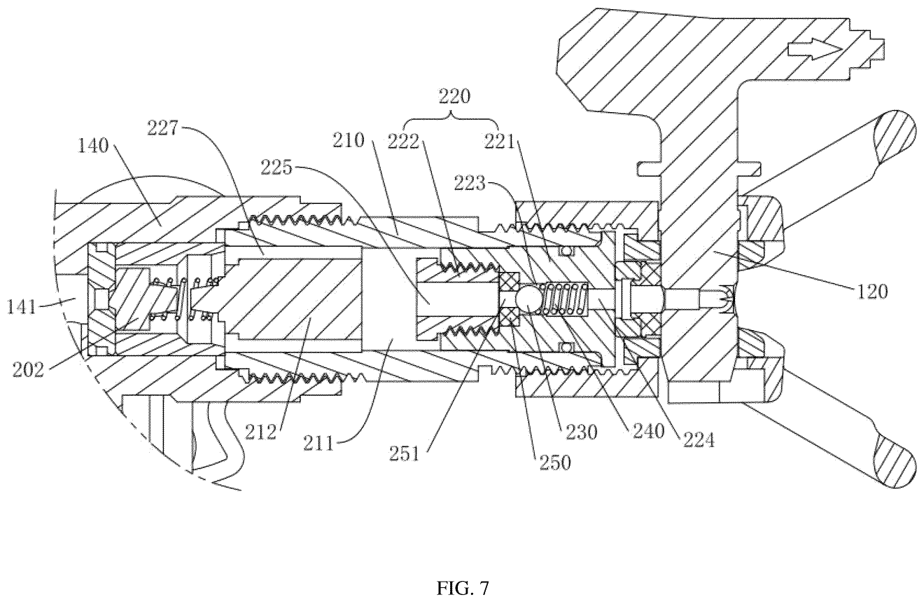

FIGS. 6 and 7 illustrate a second alternative solution of the liquid outlet valve 200, which differs from the first alternative solution in that the valve seat 220 comprises a valve seat body 221 and a poppet 222, the poppet 222 and the valve seat body 221 being securely connected in a detachable manner, the poppet 222 being mounted at one end of the valve seat body 221 distal from the nozzle 120, a limiting cavity 223 configurable to limit the valve head 230 and the spring 240 being formed between the poppet 222 and the valve seat body 221 so that movement of the valve head 230 in the limiting cavity 223 is limited to a certain extent. By disposing the poppet 222 at the end of the valve seat 220 distal from the nozzle 120 and limiting the valve head 230 and the spring 240 between the valve seat body 221 and the poppet 222, the size of the valve seat 220 may be reduced, which may also increase the available volume of the buffer chamber 211 and further reduce the size of the liquid outlet valve 200 while satisfying spray requirements, whereby the material cost of the liquid outlet valve 200 is reduced. Meanwhile, the detachable connection between the poppet 222 and the valve seat body 221 facilitates dismantling and internal cleaning of the valve seat 220. Furthermore, by forming the limiting cavity 223 limiting the valve head 230 and the spring 240 between the poppet 222 and the valve seat body 221, the valve head 230 is limitedly movable in the limiting cavity 223, so that the valve seat 220, the valve head 230 and the spring 240 form a detachable modular structure; in addition, the valve head 230 and the spring 240 would be kept well when dismantling the valve seat 220, and setup of the valve seat 220 and the valve body 210 is also facilitated. In this alternative solution, the fixed holder 212 is fixed in the rear end of the buffer chamber 211, a liquid inlet flow passage 227 being formed between an outer peripheral surface of the fixed holder 212 and an inner peripheral surface of the valve body 210.

Referring to FIG. 7, the poppet 222 which is hollow inside is provided with a liquid inlet hole 225 communicating with the liquid outlet hole 224, one end of the spring 240 abutting against the valve seat body 221, an opposite end thereof acting on the valve head 230 to bias the valve head 230 in a direction towards the liquid inlet hole 225. When the valve head 230 closes the liquid inlet hole 225, no liquid would flow towards the liquid outlet hole 224, whereby the liquid outlet hole 224 is closed. In this solution, the valve head 230 is formed of a spherical shape, a diameter of the valve head 230 being greater than a diameter of the liquid inlet hole 225, so that the valve head 230 partially enters the liquid inlet hole 225 to thereby close the liquid inlet hole 225. By forming the liquid inlet hole 225 on the poppet 222, the liquid pressure in the buffer chamber 211 may directly act on the valve head 230, which facilitates opening of the valve head 230 and improves spray sensitivity of the sprayer. The liquid pressure is imposed on the valve head 230; when the liquid pressure is greater than a preset liquid outlet pressure, the valve head 230 is pushed away from the liquid inlet hole 225. In some other equivalent implementations, the valve head 230 may be formed of a conical shape or at least partially formed of a conical shape.

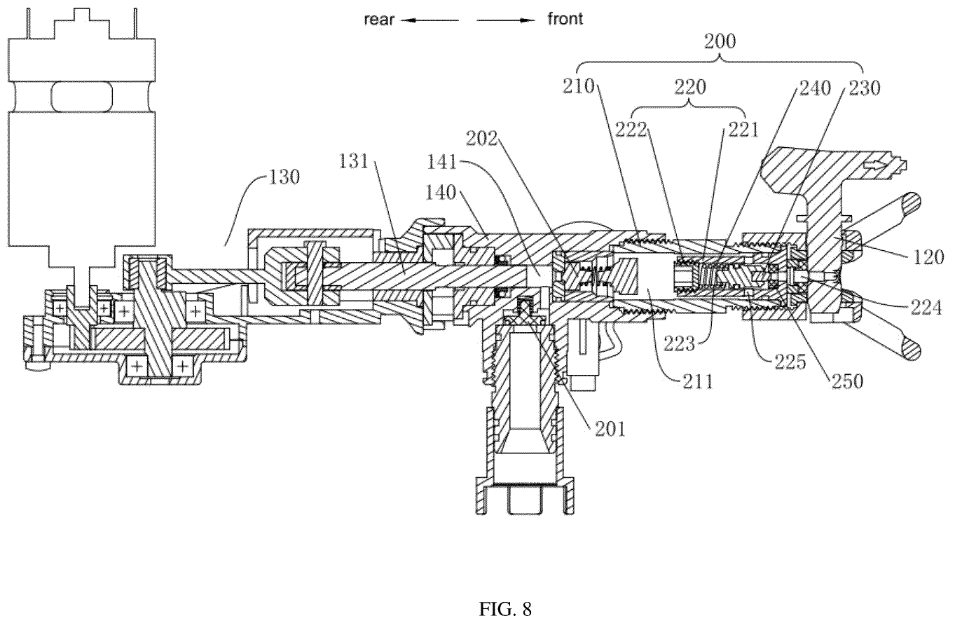

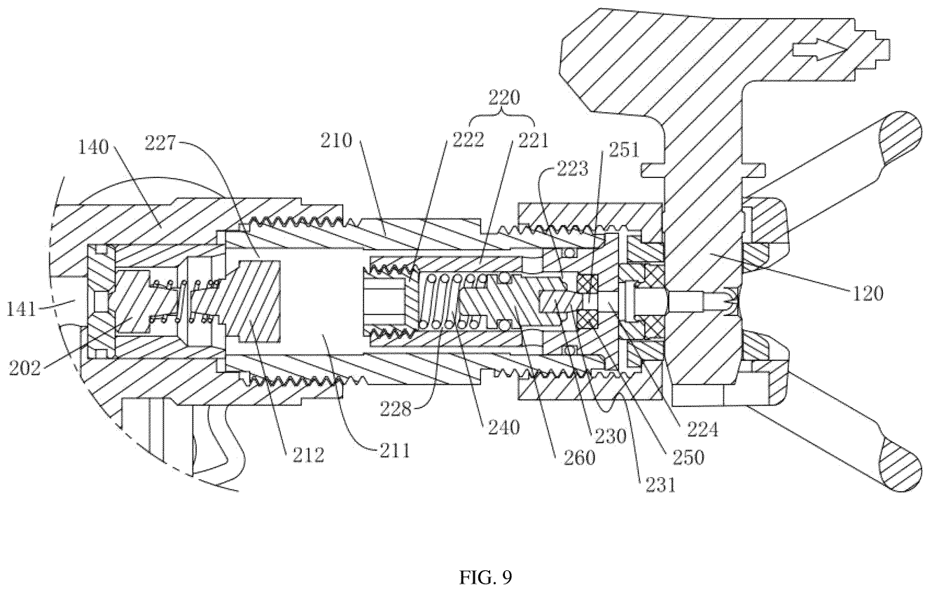

Referring to FIGS. 8 and 9, in a third alternative solution of the liquid outlet valve 200, the liquid outlet valve 200 comprises a valve stem 260, the valve stem 260 being slidably arranged in the valve seat body 221; a seal ring sleeves over the valve stem 260, the seal ring forming peripheral sealing between the valve stem 260 and the valve seat body 221; and a sealing cavity 228 is formed by a portion of the limiting cavity 223 between the valve stem 260 and the poppet 222. The spring 240 is disposed in the sealing cavity 228, a rear end of the spring 240 abutting against the poppet 222, a front end of the spring 240 abuts against the valve stem 260, the valve head 230 being fixed to the front end of the valve stem 260. The valve head 230 is formed with a conical tip, the conical tip partially projecting into the through hole 251 on the valve plate 250 so as to close the liquid outlet hole 224. In this solution, the liquid inlet hole 225 is provided on a sidewall of the valve seat body 221 and may communicate with the liquid outlet hole 224 through the limiting cavity 223 and the through hole 251. In this solution, the fixed holder 212 is fixed in the rear end of the buffer chamber 211, a liquid inlet flow passage 227 being formed between an outer peripheral surface of the fixed holder 212 and the inner peripheral surface of the valve body 210. The liquid pressure in the buffer chamber 211 is peripherally applied on the conical tip of the valve head 230, so that the liquid pressure may be decomposed into forces in directions opposite the liquid outlet hole 224 and forces in directions towards the center of the valve head 230, where the forces directed towards the center of the valve head 230 counteract each other; when the forces in directions opposite the liquid outlet hole 224 are superimposed to exceed a preset liquid outlet pressure, the liquid pushes the valve head 230 to move in the direction opposite the liquid outlet hole 224, whereby the liquid outlet hole 224 is opened so that the liquid may flow through the liquid outlet hole 224 to the nozzle 120 where it is sprayed out, thereby implementing spraying. Since the spring 240 is disposed in the sealing cavity 228, the spring 240 is isolated from the liquid without being rusted thereby.

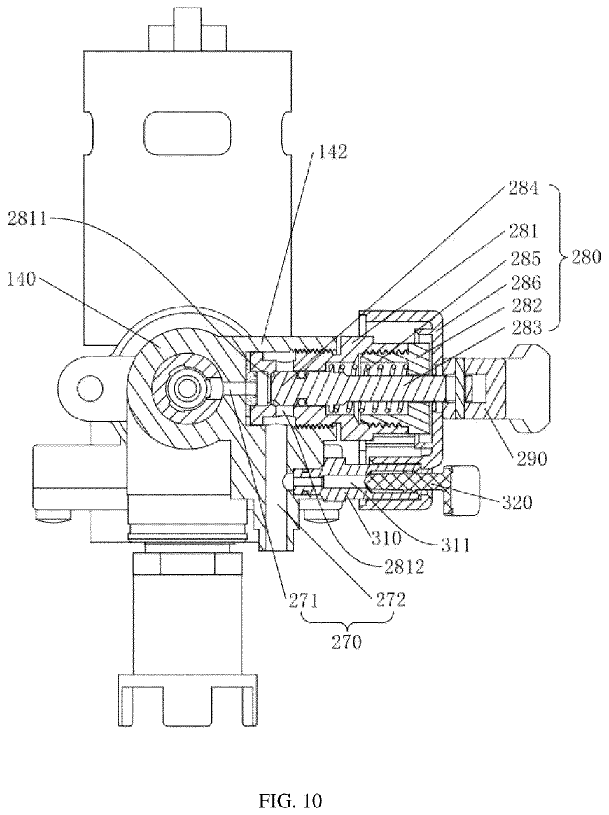

Referring to FIG. 10, based on different liquid outlet valves 200 in the three alternative solutions described supra, the pump body 140 is further provided with a pressure relief passage 270, the pressure relief passage 270 comprising a first passage section 271 communicating with the pump chamber 141 and a second passage section 272 communicating with the liquid cup 110, a pressure relief valve 280 being arranged between the first passage section 271 and the second passage section 272, a preset relief pressure of the pressure relief valve 280 being greater than the preset liquid outlet pressure of the liquid outlet valve 200.

In this solution, the pump body 140 is provided with a pressure relief valve mount portion 142 configured to mount the pressure relief valve 280, the first passage section 271 being disposed between the pump chamber 141 and the pressure relief valve mount portion 142, the second passage section 272 being disposed between the liquid cup 110 and the pressure relief valve mount portion 142; the pressure relief valve 280 is operable to close the first passage section 271 to limit the liquid in the buffer chamber 211 from flowing back into the liquid cup 110. When the liquid pressure exceeds the preset relief pressure, the pressure relief valve 280 is opened, allowing for the liquid in the pump chamber 141 to flow back into the liquid cup 110, thereby preventing an excessively high liquid pressure in the buffer chamber 211. When the liquid pressure in the buffer chamber 211 is excessively high, the liquid in the buffer chamber 211 directly flows back into the liquid cup 110 through the pressure relief passage 270, which may also prevent heating of the actuation mechanism 130 due to an overly large working resistance.

In the first alternative solution of the pressure relief valve 280 illustrated in FIG. 10, the pressure relief valve 280 is disposed in the casing 100, the pressure relief valve 280 being detachably mounted in the pressure relief valve mount portion 142. The pressure relief valve 280 comprises a pressure relief valve housing 281, a pressure relief poppet 282, a pressure relief valve stem 283, a pressure relief valve head 284, and a pressure relief spring 285, a first pressure relief hole 2811 and a second pressure relief hole 2812 that may communicate with each other being provided on the housing 281, the first pressure relief hole 2811 communicating with the first passage section 271, the second pressure relief hole 2812 communicating with the second passage section 272. The pressure relief valve stem 283 is movably arranged on the housing 281 and the pressure relief poppet 282, one end of the pressure relief spring 285 abutting against the pressure relief poppet 282, an opposite end of the pressure relief spring 285 abutting against the pressure relief valve stem 284, the pressure relief valve head 284 being disposed at one end of the pressure relief valve stem 283 facing the first pressure relief hole 2811. The pressure relief spring 285 has an elasticity; the pressure relief spring 285 acts on the pressure relief valve stem 283 to bias the pressure relief valve head 284 towards a direction of closing the first pressure relief hole 2811 so that the valve head 284 closes the first pressure relief hole 2811, which may prevent the liquid in the buffer chamber 211 from backflow from the pressure relief passage 270; the elastic force applied by the pressure relief spring 285 on the pressure relief valve head 284 determines the magnitude of the preset relief pressure. When the liquid pressure in the buffer chamber 211 exceeds the preset relief pressure, the liquid pushes the pressure relief valve head 284 to move to open the first pressure relief hole 2811, allowing for the liquid in the buffer chamber 211 to access from the first passage section 271 and flow back through the first pressure relief hole 2811, the second pressure relief hole 2812, and the second passage section 272 into the liquid cup 110. A pressure relief valve plate 287 is further provided at one end of the pressure relief valve 280 proximal to the first passage section 271, the pressure relief valve plate 287 being disposed between the housing 281 and the pump body 140 to prevent leakage from between the first passage section 271 and the first pressure relief hole 2811. A conical surface 2841 is formed on the pressure relief valve head 284, the conical surface 2841 abutting against the first pressure relief hole 2811, so that the first pressure relief hole 2811 is closed when the liquid pressure in the buffer chamber 211 is lower than the preset relief pressure. In this solution, the pressure relief valve head 284 and the pressure relief valve stem 283 may be unitarily formed, or separately formed and then assembled together. In addition, in this implementation, the pressure relief valve head 284 may be formed of a conical shape or a spherical shape.

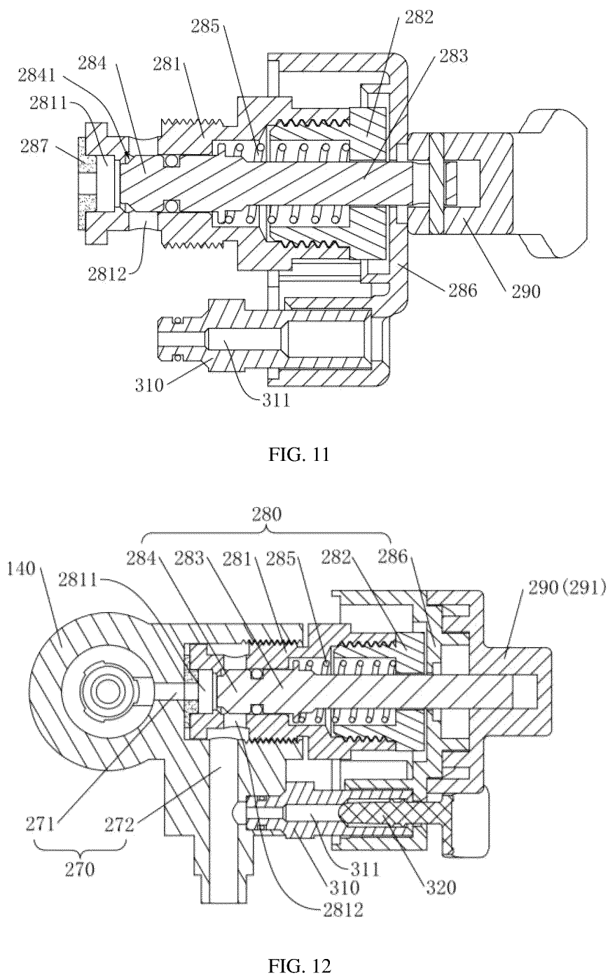

Referring to FIGS. 10 and 11, in this alternative solution, the second passage section 272 also serves as an exhaust channel for expelling the gas in the liquid cup 110 out; an exhaust base 310 and an exhaust plug 320 are arranged on the pump body 140, on the exhaust base 310 being arranged an exhaust hole 311 communicating with the second passage section 272, the exhaust plug 320 being removably inserted in the exhaust hole 311 and operable to open and close the exhaust hole 311.

Furthermore, the pressure relief valve 280 further comprises a pressure relief bonnet 286, the pressure relief valve stem 283 extending axially along the first passage section 271 to project out of the pressure relief bonnet 286, at a tail end of the pressure relief valve stem 283 being mounted a manipulator 290, the manipulator 290 being operable to drive the pressure relief valve stem 283 to move in the direction opposite the first passage section 271 so that the pressure relief valve head 284 opens the first pressure relief hole 2811, causing the pressure relief valve 280 to actively release pressure. With this setup, a user may manipulate the pressure relief valve 280 to release pressure actively, preventing the buffer chamber 211 from still maintaining a high-pressure state after the handheld airless sprayer is deactivated. In this solution, the manipulator 290 may be a pull lever or a poke lever, so that the user pulls or pokes the manipulator 290 to realize active pressure relief; the direction of the force exerted by the pull lever or poke lever is parallel to the movement direction of the pressure relief valve stem 283, so that the user may perform an active pressure relief operation more directly.

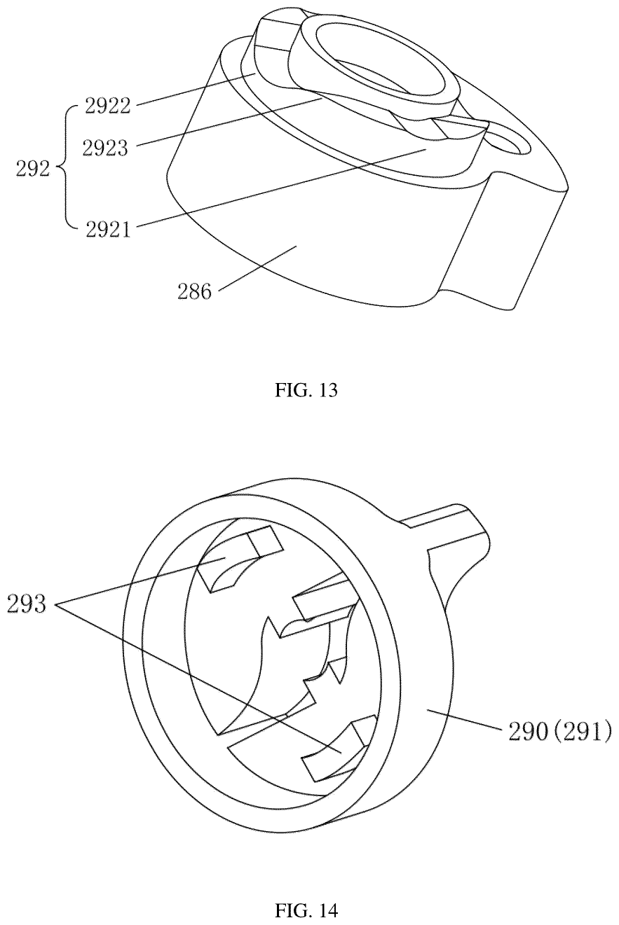

Referring to FIGS. 12, 13, and 14, in a second alternative solution of the pressure relief valve 280, the manipulator 290 is a rotary knob 291, the rotary knob 291 being cover-fitted on the outer side of the pressure relief bonnet 286 and rotatable relative to the pressure relief bonnet 286; a support portion 292 is provided on the pressure relief bonnet 286, and an abutting portion 293 is provided on the rotary knob 291; the pressure relief spring 285 acts on the rotary knob 291 so that the abutting portion 293 abuts against the support portion 292; the support portion 292 comprises a first support section 2921 and a second support section 2922 which project with different heights so that the abutting portion 293 is supported by the first support section 2921 and the second support section 2922 at different positions, respectively. When the abutting portion 293 abuts against the first support section 2921, the pressure relief valve 280 may release pressure actively. When the abutting portion 293 abuts against the second support section 2922, the pressure relief valve 260 suspends active pressure relief. Alternatively, the abutting portion 293 may also be arranged on the pressure relief bonnet 286; in this case, the support portion 292 is arranged on the rotary knob 291. The user rotates the rotary knob 291 so that the abutting portion 293 abuts against different positions of the support portion 292 to enable the pressure relief valve 280 to actively release pressure or suspends pressure relief, which simplifies manipulation of the manipulator 290. In this solution, holes are provided on both of the tail end of the pressure relief valve stem 283 and the rotary knob 291, where a locating pin is inserted through the holes to enable the rotary knob 291 to drive the pressure relief valve stem 283 to move.

Furthermore, the support portion 292 further comprises a partition section 2923 arranged between the first support section 2921 and the second support section 2922, a surface of the partition section 2923 gradually changing from the first support section 2921 towards the second support section 2922.

The rotary knob 291 may be fitted with the partition section 2923 so that the rotary knob 291 is rotated to shift between the first support section 2921 and the second support section 2922; in this way, during the process of rotating the rotary knob 291, the abutting portion 293 may shift its position on the support portion 292 without a need for the user to lift the rotary knob 291, which facilitates manipulation of the manipulator 290 to relieve pressure actively.

In some implementations, the abutting portion 293 is formed of a convex arc shape, and the second support section 2922 is formed of a concave arc shape adapted to the abutting portion 293, which facilitates shifting the abutting portion 293 between the first support section 2921 and the second support section 2922. Meanwhile, the second support section 2922 is shaped to adapt the abutting portion 293 so as to better retain the positions of the abutting portion 293 and the second support section 2922 when the pressure relief valve 280 stops pressure relief, whereby relative displacement therebetween is reduced or prevented.

In some implementations, the first support section 2921 is at least partially formed of a concave arc shape adapted to the abutting portion 293, so that the position of the abutting portion 293 abutting against the first support section 2921 can be retained, which reduces or prevents the abutting portion 293 from slipping off the first support section 2921 upon active pressure relief.

What have been described supra are only specific implementations of the disclosure, and the scope of protection of the disclosure is not limited thereto. Those skilled in the art would appreciate that the disclosure includes, but is not limited to, the contents described in the drawings and the specification implementations. Any modification without departing from the functional and structural principles of the disclosure shall fall within the scope set forth in the appended claims.

1. A handheld airless sprayer, comprising a casing, a liquid cup, a nozzle, a pump body, an actuation mechanism, and a liquid outlet valve, the nozzle being disposed at a front end of the casing, the pump body being provided with a pump chamber, a liquid inlet end of the pump chamber being connected to the liquid cup via a first check valve, a liquid outlet end of the pump chamber being connected to the liquid outlet valve via a second check valve, wherein the liquid outlet valve comprises a valve body, a valve seat, a valve head, and a spring, the valve body being provided with a buffer chamber, the valve seat, the valve head, and the spring being arranged in the valve body; a liquid outlet hole communicating with the nozzle is provided on the valve seat; the spring acts on the valve head to bias the valve head towards a direction of closing the liquid outlet hole; the actuation mechanism activates the pump body to draw liquid from the liquid cup into the buffer chamber; and the valve head is opened when a liquid pressure in the buffer chamber exceeds a preset liquid outlet pressure, whereby the liquid in the buffer chamber flows through the liquid outlet hole and is sprayed out of the nozzle.

2. The handheld airless sprayer of claim 1, wherein the valve seat comprises a valve seat body and a poppet, the poppet being fixedly connected to the valve seat body in a detachable manner, the poppet being mounted at one end of the valve seat body distal from the nozzle, a limiting cavity configured to limit the valve head and the spring being formed between the poppet and the valve seat body, the valve head being movable in the limiting cavity.

3. The handheld airless sprayer of claim 2, wherein the poppet is hollow inside and provided with a liquid inlet hole communicating with the liquid outlet hole, the valve head being operable to open and close the liquid inlet hole leading to opening and closing of the liquid outlet hole.

4. The handheld airless sprayer of claim 2, wherein the liquid outlet valve further comprises a valve stem, the valve stem being slidably arranged in the valve seat body, the valve stem and the valve seat body being peripherally sealed so that a sealing cavity is formed between the valve stem and the poppet, the spring being disposed in the sealing cavity, one end of the spring abutting against the poppet, an opposite end of the spring abutting against the valve stem, the valve head being disposed on the valve stem; and the valve head comprises a conical tip, the conical tip being partially inserted in the liquid outlet hole to close the liquid outlet hole.

5. The handheld airless sprayer of claim 1, wherein a fixed holder is arranged in one end of the valve body proximal to the pump body; the valve body further comprises a valve stem, the valve head being fixed on the valve stem; a blind hole is provided on the fixed holder, one end of the valve stem being movably inserted in the blind hole, one end of the spring abutting against the fixed holder, an opposite end of the spring abutting against the valve stem; and the valve head comprises a conical tip, the conical tip being partially inserted in the liquid outlet hole to close the liquid outlet hole.

6. The handheld airless sprayer of claim 1, wherein the actuation mechanism acts on the pump body to induce volume change of the pump chamber, a ratio of maximum volume of the pump chamber to a liquid accommodable volume of the buffer chamber ranging from 1:1 to 1:50.

7. The handheld airless sprayer of claim 1, wherein the pump body is further provided with a pressure relief passage, the pressure relief passage comprising a first passage section communicating with the pump chamber and a second passage section communicating with the liquid cup; and a pressure relief valve is arranged between the first passage section and the second passage section, a preset relief pressure of the pressure relief valve being greater than the preset liquid outlet pressure of the liquid outlet valve.

8. The handheld airless sprayer of claim 7, wherein the pressure relief valve comprises a pressure relief valve body, a pressure relief poppet, a pressure relief valve stem, a pressure relief valve head, and a pressure relief spring; a first pressure relief hole and a second pressure relief hole that communicate with each other are provided on the pressure relief valve body, the first pressure relief hole communicating with the first passage section, the second pressure relief hole communicating with the second passage section; the pressure relief valve stem is movably mounted on the pressure relief poppet; one end of the pressure relief spring abuts against the pressure relief poppet, and an opposite end thereof abuts against the pressure relief valve stem; the pressure relief valve head is fixed on the pressure relief valve stem; a conical surface is formed on the pressure relief valve head; and the pressure relief spring acts on the pressure relief valve stem to bias the conical surface in a direction towards the first pressure relief hole, the first pressure relief hole being closed by the pressure relief valve head when liquid pressure in the buffer chamber is lower than the preset relief pressure.

9. The handheld airless sprayer of claim 8, wherein the pressure relief valve further comprises a pressure relief bonnet, the pressure relief valve stem extending in a direction opposite the first passage section to project out of the pressure relief bonnet; and a manipulator is mounted at a tail end of the pressure relief valve stem, the manipulator being operable such that the pressure relief valve head opens the first pressure relief hole, leading to active pressure relief of the pressure relief valve.

10. The handheld airless sprayer of claim 9, wherein the manipulator comprises a rotary knob, the rotary knob being cover-fitted on the pressure relief bonnet and rotatable relative to the pressure relief bennet, a support portion being arranged on one of the pressure relief bonnet and the rotary knob, an abutting portion being arranged on the other one of the pressure relief bonnet and the rotary knob, the pressure relief spring acting on the rotary knob so that the abutting portion abuts against the support portion; and the support portion comprises a first support section and a second support section, wherein when the abutting portion abuts against the first support section, the pressure relief valve releases pressure actively, and when the abutting portion abuts against the second support section, the pressure relief valve suspends active pressure relief.

11. The handheld airless sprayer of claim 10, wherein the support portion further comprises a partition section arranged between the first support section and the second support section, a surface of the partition section changing gradually in a direction from the first support section towards the second support section.

12. The handheld airless sprayer of claim 11, wherein the abutting portion is formed of a convex arc shape, and the second support section is formed of a concave arc shape adapted to the abutting portion.

13. The handheld airless sprayer of claim 12, wherein the first support section is at least partially formed of a concave arc shape adapted to the abutting portion.
